(19) United States
(12) Patent Application Publication
(10) Pub. No.: US 2010/0174043 A1
(43) Pub. Date: Jul. 8, 2010

(54) PROCESS FOR PRODUCING ORIENTED THERMOPLASTIC RESIN FILM, APPARATUS THEREFOR AND BASE FILM FOR OPTICAL FILM

(75) Inventors: Masaaki Otoshi, Kanagawa (JP); Shinichi Nakai, Kanagawa (JP); Yasuyuki Maki, Kanagawa (JP)

Correspondence Address: YOUNG & THOMPSON, 209 Madison Street, Suite 500, Alexandria, VA, 22314, US

(73) Assignee: FUJIFILM CORPORATION, Tokyo (JP)

(21) Appl. No.: 12/602,131

(22) PCT Filed: May 22, 2008
(86) PCT No.: PCT/JP2008/059424

§ 371 Date: Nov. 27, 2009

(30) Foreign Application Priority Data
May 31, 2007 (JP) 2007-145727

(51) Int. Cl. C08G 63/00; B29C 55/06; C08J 5/18; B29C 55/14; B29C 35/08

(52) U.S. Cl. 528/271; 264/448; 425/174.4

(57) ABSTRACT

Electromagnetic waves radiated when a formed polyester film 18 is longitudinally drawn while one surface of the front and rear surfaces of the polyester film 18 is being heated by a radiant heater 30, are composed of such a wavelength band that a thermal energy of 20% or more and 50% or less of the total thermal energy radiated onto the one surface of the polyester film 18 can transmit from the one surface to the other surface. Thereby, even in the case where the film is longitudinally drawn while one surface of the film is being heated in the longitudinal drawing step, a curl is not easily generated in the film.

### TECHNICAL FIELD

The present invention relates to a process for producing an oriented thermoplastic resin film, an apparatus therefor, and a base film for an optical film, and particularly relates to a process for producing an oriented thermoplastic resin film which is suitably used for various optical members used in liquid crystal displays (LCD), plasma displays (PDP) and the like and for protective films, release films and the like used in production processes of products in the optical field, and which has a low curl value, good flatness and excellent optical characteristics, and an apparatus therefor and a base film for an optical film.

### BACKGROUND ART

Polyester films, particularly, oriented films of polyethylene terephthalate and polyethylene naphthalate, have excellent mechanical properties, heat resistance and chemical resistance, and are conventionally broadly used as materials (base films) for magnetic tapes, ferromagnetic thin film tapes, photographic films, packaging films, films for electronic members, electric insulating films, films for metal laminates, films attached to glass surfaces such as glass display films, protective films for various members and the like.

Recently, polyester films have often been used particularly as base films for various types of optical applications, and used for the various types of applications including base films for prism sheets, light diffusion sheets, reflectors, touch panels and the like as members of LCD, antireflection base films, base films for explosion-proof displays, and films for PDP filters. In such optical products, in order to provide bright and clear images, base films used as optical films need to have good transparency and be free from foreign matter and defects such as scratches affecting images because of the way the base films are used. In addition thereto, particularly, even in the case of using polarization of light, the base films need to exhibit no polarization unevenness caused by orientation unevenness and thickness unevenness of the polymers.

Production of a base film for an optical film of such a type has conventionally been carried out in which a melted thermoplastic resin discharged from a die is cast on a cooling drum to quench and solidify the resin to obtain a film; the obtained film is longitudinally drawn by a heating draw roll and a cooling draw roll having different peripheral speeds, and thereafter transversely drawn in a tenter whose temperature is kept at a predetermined one to produce the base film (see Patent Document 1).
Patent Document 1: Japanese Patent Application. Laid-Open No. 2000-263642

### DISCLOSURE OF THE INVENTION

### Problems to be Solved by the Invention

However, in the above-mentioned longitudinal drawing step, if a film is longitudinally drawn while one surface of the front and rear surfaces of the film is being heated by a radiant heater, there arises a problem that the temperature difference between the front and rear surfaces causes the film to curl. Reduced flatness due to the curl generated in longitudinal drawing of a film cannot provide a base film for an optical film excellent in optical characteristics.

Although it is understood to suffice as a countermeasure therefor if heaters are arranged on both sides, or the front and rear surfaces, of a film, a heater can be arranged only on one surface of the front and rear surfaces of a film in many cases for reasons concerned with the installation spaces in the installation portions where a heating draw roll and a cooling draw roll are arranged.

Therefore, even in the case where a film is longitudinally drawn while one surface of the front and rear surfaces of the film is being heated by a radiant heater, a countermeasure to prevent a curl on the film has been requested. Particularly as a base film for an optical film, a polyester film is often used which has a relatively large thickness of approximately 800 μm or more and 4,000 μm or less; therefore, the temperature difference between the front and rear surfaces is liable to become large, and there arises the problem of the curl generated more easily.

The present invention has been achieved in consideration of such a situation, and an object thereof is to provide a process for producing an oriented thermoplastic resin film which can produce the oriented thermoplastic resin film having good flatness and excellent optical characteristics because no curl is generated on the film even in the case where the film is longitudinally drawn while one surface of the front and rear surfaces of the film is being heated by a radiant heater during the longitudinal drawing step, and to provide an apparatus therefor and a base film for an optical film produced by the producing process.

### Means for Solving the Problems

In order to achieve the above-mentioned object, a process for producing an oriented thermoplastic resin film according to a first aspect of the present invention comprises the longitudinal drawing step of longitudinally drawing a belt-like thermoplastic resin film while one surface of the front and rear surfaces of the film is being heated by radiant heating, wherein electromagnetic waves radiated during the heating are composed of a wavelength band having such a transmittance that a thermal energy of 20% or more and 50% or less of the total thermal energy radiated onto the one surface of the thermoplastic resin film can transmit from the one surface to the other surface.

According to the first aspect, in the longitudinal drawing step of a thermoplastic resin film, since electromagnetic waves radiated during the heating are composed of a wavelength band having such a transmittance that a thermal energy of 20% or more and 50% or less of the total thermal energy radiated onto one surface of the thermoplastic resin film can transmit from the one surface to the other surface, the temperature difference between the front and rear surfaces of the film can be made small. Thereby, an oriented thermoplastic resin film can be produced which generates no curl during longitudinal drawing and has good flatness and excellent optical characteristics. In this case, a too low transmittance of the thermal energy of less than 20% makes large the temperature difference between the front and rear surfaces of the film and causes a curl to be generated on the film. By contrast, if the transmittance of the thermal energy is too high, more than 50%, since the film temperature does not rise to a desired longitudinal drawing temperature during longitudinal drawing, the longitudinal draw ratio cannot suitably be secured.

The first aspect of the present invention has changed conventional ideas giving weight to the thermal efficiency of the thermal energy relevant to film heating in longitudinal drawing and has given attention to the transmissivity of the thermal energy through a film, and has thus solved the problem.

According to a second aspect of the present invention, the process for producing an oriented thermoplastic resin film according to the first aspect further comprises the shift control step of shifting the wavelength band so that the above-mentioned transmittance is attained, depending on the thickness of the thermoplastic resin film.

In the case where the wavelength band of electromagnetic waves radiated during heating is constant, the transmittance of the electromagnetic waves becomes low when a thermoplastic resin film has a large thickness; and the transmittance of the electromagnetic waves becomes high when the thermoplastic resin film has a small thickness. Therefore, the wavelength band of electromagnetic waves is preferably shifted so that the transmittance becomes 20% or more and 50% or less, depending on the thickness of the thermoplastic resin film.

According to a third aspect of the present invention, in the process for producing an oriented thermoplastic resin film according to the first aspect or the second aspect, the thickness of the thermoplastic resin film is 800 μm or more and 4,000 μm or less before the longitudinal drawing.

As a base film for an optical film, a thick one having a thickness of 800 μm or more and 4,000 μm or less before longitudinal drawing is commonly used and the process for producing an oriented thermoplastic resin film according to the third aspect is effective especially for such a film.

According to a fourth aspect of the present invention, in the process for producing an oriented thermoplastic resin film according to any one of the first to third aspects, the thermoplastic resin film is a polyester film.

Thereby, a polyester film can be provided which generates no curl during longitudinal drawing and has good flatness and excellent optical characteristics.

According to a fifth aspect of the present invention, the process for producing an oriented thermoplastic resin film according to any one of the first to fourth aspects, further comprises the step of controlling so that the temperature difference between one surface and the other surface of the thermoplastic resin film is 20° C. or lower in the heating.

By thus making the temperature difference between one surface and the other surface of a thermoplastic resin film equal to or lower than 20° C., the generation of a curl during longitudinal drawing can be suppressed more securely.

According to a sixth aspect of the present invention, in the process for producing an oriented thermoplastic resin film according to any one of the first to fifth aspects, electromagnetic waves radiated during the heating are near-infrared rays of a maximum energy wavelength of 0.8 μm or higher and 2.5 μm or lower.

Near-infrared rays out of light rays generating radiant heat are excellent in energy transmissivity and especially near-infrared rays of a maximum energy wavelength of 0.8 μm or higher and 2.5 μm or lower are preferable. Use of near-infrared rays having such wavelengths can more securely suppress the generation of a curl during longitudinal drawing.

According to a seventh aspect of the present invention, the process for producing an oriented thermoplastic resin film according to any one of the first to sixth aspects, further comprises the step of controlling so that peak heights in the X-ray diffraction for the front and rear surfaces of the oriented thermoplastic resin film on completion of the longitudinal drawing step have a relationship where the peak height for one surface having the higher peak height is 200 or lower when the peak height for one surface having the smaller peak height out of the front and rear surfaces of the film is defined as 100, and so that the difference in refractive index in the film conveyance direction between the front and rear surfaces of the film on completion of the longitudinal drawing step is 0.04 or less.

The difference in temperature between the front and rear surfaces of a film when the film is heated emerges as a difference in the peak height in the X-ray diffraction between the front and rear surfaces of the film, and as a difference in the maximum refractive index therebetween. Therefore, specifying the differences in the peak height and the maximum refractive index also can more securely suppress the generation of a curl.

According to an eighth aspect of the present invention, the process for producing an oriented thermoplastic resin film according to any one of the first to seventh aspects, further comprises a transverse drawing step after the longitudinal drawing step.

Making a product by subjecting an oriented thermoplastic resin film to a transverse drawing step after a longitudinal drawing step can make the curl value on the product low.

According to a ninth aspect of the present invention, in the process for producing an oriented thermoplastic resin film according to the eighth aspect, the oriented thermoplastic resin film has a curl value after the transverse drawing, of 20 mm or lower.

Making the curl value when a product is produced, equal to or lower than 20 mm can provide an oriented thermoplastic resin film having good flatness and excellent optical characteristics.

In order to achieve the above-mentioned object, according to a tenth aspect of the present invention, a base film for an optical film is provided which is produced by a process for producing an oriented thermoplastic resin film according to any one of the first to ninth aspects.

Producing a base film for an optical film by a process for producing an oriented thermoplastic resin film according to any one of the first to ninth aspects can provide a base film for an optical film having good flatness and excellent optical characteristics.

In order to achieve the above-mentioned object, according to an eleventh aspect of the present invention, an apparatus for producing a thermoplastic resin film comprises a longitudinal drawing step section to longitudinally draw a belt-like thermoplastic resin film while one surface of the front and rear surfaces of the film is being heated by a radiant heater, wherein electromagnetic waves radiated by the heater are in a wavelength band having such a transmittance that a thermal energy of 20% or more and 50% or less of the total thermal energy radiated onto the one surface of the thermoplastic resin film transmits from the one surface to the other surface.

The eleventh aspect is an apparatus for producing a thermoplastic resin film to achieve each step carried out in a process according to the first aspect. In the longitudinal drawing step section in the production apparatus, use of electromagnetic waves composed of a wavelength band having such a transmittance that a thermal energy of 20% or more and 50% or less of the total thermal energy radiated onto one surface of the thermoplastic resin film transmits from the one surface to the other surface can prevent the film from curling during longitudinal drawing.

According to a twelfth aspect of the present invention, the apparatus for producing an oriented thermoplastic resin film according to the eleventh aspect further comprises a control apparatus which controls the wavelength band of the near-infrared rays so that the transmittance is attained, depending on the thickness of the thermoplastic resin film, wherein electromagnetic waves radiated from the heater are near-infrared rays having a maximum energy wavelength of 0.8 μm or higher and 2.5 μm or lower.

Near-infrared rays out of electromagnetic waves used in radiant heating have excellent energy transmissivity, and can suitably be used for each aspect of the present invention, and are especially preferably near-infrared rays having a maximum energy wavelength of 0.8 μm or higher and 2.5 μm or lower. Use of near-infrared rays having such wavelengths can more securely suppress the generation of a curl during longitudinal drawing.

### Advantages of the Invention

The process and apparatus for producing an oriented thermoplastic resin film according to the aspects of the present invention can longitudinally draw even a thermoplastic resin film having a relatively large thickness without generating a curl.

Therefore, a base film for an optical film produced by the present invention has good flatness and excellent optical characteristics.

### BRIEF DESCRIPTION OF THE DRAWINGS

FIG. 1 is a whole constitution diagram of a production apparatus of an oriented thermoplastic resin film according to the present invention;

FIG. 2 is an illustrative diagram of a film forming step section;

FIG. 3 is an illustrative diagram of a near-infrared ray heater in a longitudinal drawing step section;

FIG. 4 is an illustrative diagram of the film transmittance of radiant heat emitted from the near-infrared ray heater; and

FIG. 5 is a table showing test conditions and curl values of Examples of the present invention and Comparative Examples.

### DESCRIPTION OF SYMBOLS

10 . . . Apparatus for producing oriented thermoplastic resin film
12 . . . Die
14 . . . Melted polyester resin
16 . . . Cooling drum
18 . . . Polyester film
20 . . . Longitudinal drawing step section
22 . . . Low-speed nip roller
24 . . . Transverse drawing step section
26 . . . High-speed nip roller
28 . . . Winding step section
30 . . . Near-infrared ray heater
30A . . . Near-infrared ray lamp
30B . . . Reflection mirror

### BEST MODE FOR CARRYING OUT THE INVENTION

Hereinafter, preferable embodiments of the process and apparatus for producing an oriented thermoplastic resin film and the base film for an optical film according to the present invention will be described in connection with accompanying drawings.

The kind of the thermoplastic resin is not especially limited and the present invention is applicable to polyethylene, polypropylene, polyamide and the like, but in the present embodiments, polyester, which is especially preferable as a base film for an optical film, is taken as an example to describe the thermoplastic resin below.

Polyesters used in the embodiments of the present invention are polymers obtained by polycondensation of a dial and a dicarboxylic acid. Dicarboxylic acids are represented by terephthalic acid, isophthalic acid, phthalic acid, naphthalene dicarboxylic acid, adipic acid, sebacic acid and the like; and diols are represented by ethylene glycol, triethylene glycol, tetramethylene glycol, cyclohexane dimethanol and the like. The polyesters specifically include, for example, polyethylene terephthalate, polytetramethylene terephthalate, polyethylene-p-oxybenzoate, poly-1,4-cyclohexylene dimethylene terephthalate and polyethylene-2,6-naphthalene dicarboxylate. These polyesters, of course, may be homopolymers, copolymers with a monomer of a different component, or blended materials. The copolymerization components include, for example, diol components such as diethylene glycol, neopentyl glycol and polyalkylene glycol, and carboxylic acid components such as adipic acid, sebacic acid, phthalic acid, isophthalic acid and 2,6-naphthalene dicarboxylic acid.

Polyester films may be composed of a blended resin of a polyester and another polymer, but even in this case, the content of the polyester is equal to or higher than 50% by weight, and preferably equal to or higher than 80% by weight.

Polymers to be used may contain phosphoric acid, phosphorous acid and an ester thereof, and an inorganic particle (silica, kaolin, calcium carbonate, titanium dioxide, barium sulfate, alumina and the like) in the polymerization stage, or may be blended with an inorganic particle and the like after the polymerization. The polymers can also contain other additives, for example, a stabilizer, a colorant and a flame retardant.

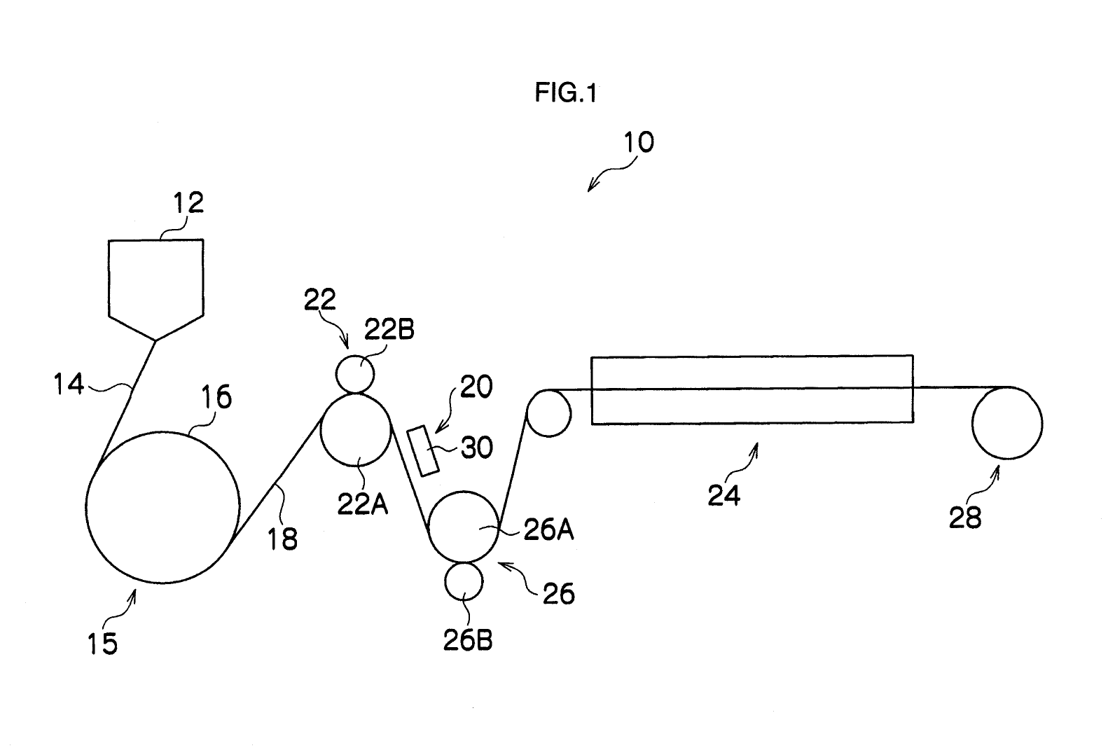

FIG. 1 is a whole constitution diagram showing an example of apparatuses for producing an oriented thermoplastic resin film according to the embodiment. Hereinafter, the production apparatus will be described by taking a polyester resin as an example of thermoplastic resins.

As shown in FIG. 1, an apparatus 10 for producing an oriented thermoplastic resin film comprises a film forming step section 15 to cool and solidify, by a cooling drum 16, a melted polyester resin 14 extruded in a sheet form (thin film form) from a die 12 to form a polyester film 18; a longitudinal drawing step section 20 to longitudinally draw the formed polyester film 18 in the flowing direction (conveyance direction) of the film; a transverse drawing step section 24 to transversely draw the longitudinally drawn polyester film 18 in the width direction; and a winding step section 28 to wind up the polyester film 18 thus biaxially drawn (longitudinally drawn and transversely drawn). In the longitudinal drawing step section 20, a heater can be arranged only on one surface of the front and rear surfaces of the film in many cases for reasons concerned with the installation spaces in the installation portions where draw rolls and like are arranged. Details of heating in the longitudinal drawing step section 20 will be described later.

First, the film forming step section 15 will be described. The polyester resin is fully dried, then melted and extruded in a sheet form through an extruder (not shown in figure) whose temperature is controlled, for example, in the range of from a temperature 10° C. higher to a temperature 50° C. higher than the melting point of the polyester resin, a filter (not shown in figure) and a die 12, and cast on a rotating cooling drum 16 (also referred to as a cast drum) to obtain a quenched and solidified film. The quenched and solidified polyester film 18 is substantially in an amorphous state.

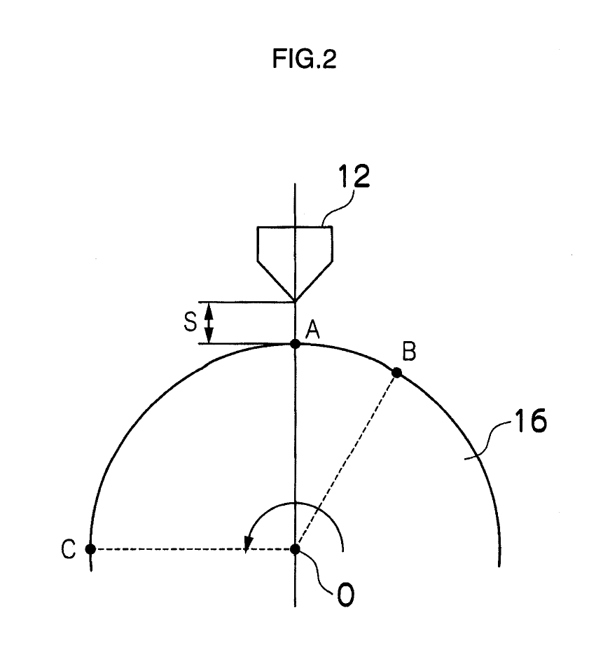

FIG. 2 is a diagram showing a preferable positional relation of the die 12 and the cooling drum 16. As shown in FIG. 2, if a line connecting the rotation axis O of the cooling drum 16 and the point A on the peripheral surface of the cooling drum right above the rotation axis O is set equal to an angle of 0°, the die 12 is preferably arranged in the range of from a position B at an angle of −20° to a position C at an angle of +90°, and more preferably in the range of from an angle of −10° to an angle of +45°. If the position where the die 12 is arranged exceeds −20° to a more negative angle, the film surface is liable to generate transverse step-like unevenness and longitudinal streaks. Here, the arrangement position of the die 12 cannot naturally become larger than 90°.

An air gap S of a distance from the front end of the die 12 to the peripheral surface of the cooling drum 16 is preferably 20 mm or more and 300 mm or less, and more preferably 40 mm or more and 140 mm or less. With the air gap S less than 20 mm, the film surface is liable to generate transverse step-like unevenness and longitudinal streaks. By contrast, the air gap S exceeding 300 mm causes film swing and generates thickness unevenness.

In order to further suppress such defects as transverse step-like unevenness, longitudinal streaks and thickness unevenness in the film forming step section 15, to the melted resin discharged in a sheet form from the die 12 installed in the above-mentioned positional relation with the cooling drum 16, a high voltage of 7 kV or higher and 15 kV or lower is preferably applied by an electrostatic application device such as a wire pinning device not shown in figure arranged in the vicinity of the cooling drum 16. This voltage application can raise the adhesion between the melted polyester resin 14 discharged from the die 12 and the cooling drum 16, and provide a quenched and solidified, unoriented polyester film.

The unoriented polyester film 18 thus obtained is fed to the longitudinal drawing step section 20 to be longitudinally drawn.

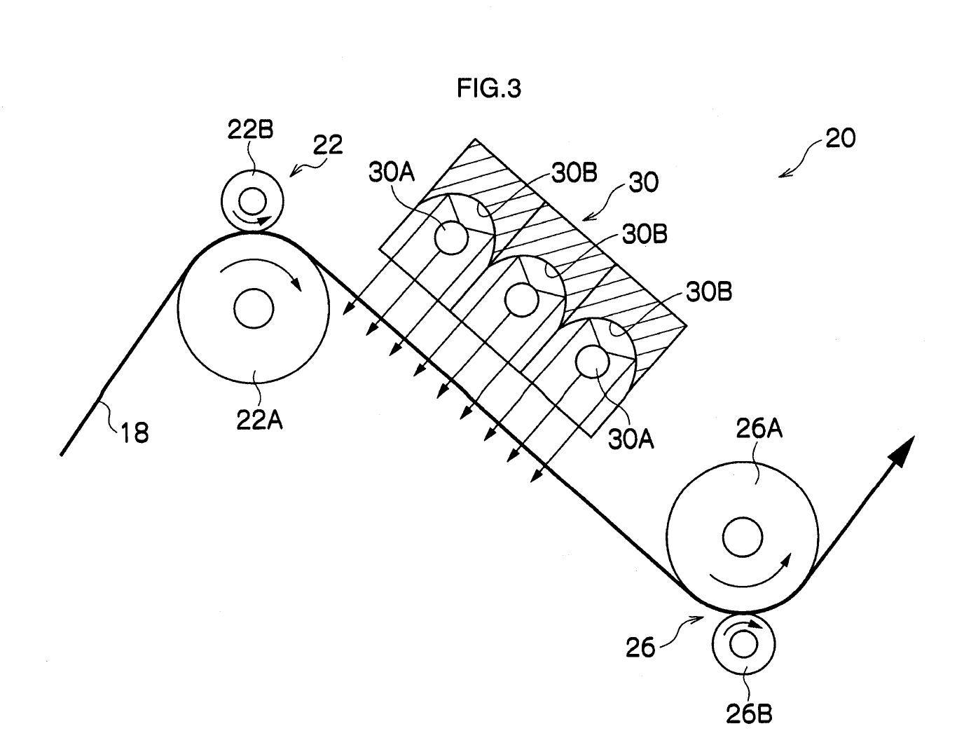

As shown in FIG. 3, the longitudinal drawing step section 20 comprises mainly a low-speed nip roll 22 composed of a pair of rolls 22A, 22B, a high-speed nip roll 26 composed of a pair of rolls 26A, 26B rotating at a higher speed than the low-speed nip roll 22, and a radiant heater 30, for example, a near-infrared ray heater, to heat the front surface of the front and rear surfaces of the polyester film 18. Although, in FIG. 3, there is a space where a heater can be arranged also on the rear surface side of the polyester film 18, actually on site, a heater cannot be arranged on the film rear surface side in many cases for reasons concerned with layouts for other devices and apparatuses as described above.

The near-infrared ray heater 30 is arranged between the low-speed nip roll 22 and the high-speed nip roll 26 and along the conveyance direction of the polyester film 18. In FIG. 3, the case where three near-infrared ray lamps 30A are tripartitely arrayed along the conveyance direction of the polyester film 18 is shown, but the number of the near-infrared ray lamps 30A can be suitably altered. The length (length in the film width direction) of the near-infrared ray lamp 30A is preferably longer than the width of the polyester film 18. A reflection mirror 30B is installed on the back surface of the near-infrared ray lamp 30A and the radiant heat emitted from the near-infrared ray lamp 30A is emitted toward the polyester film 18 as parallel light. Thereby, the polyester film 18 being longitudinally drawn is heated to a desired longitudinal drawing temperature. In this case, the conveyance speed of the polyester film 18 is preferably 5 m/min or higher and 200 m/min or lower, and more preferably 10 m/min or higher and 150 m/min or lower.

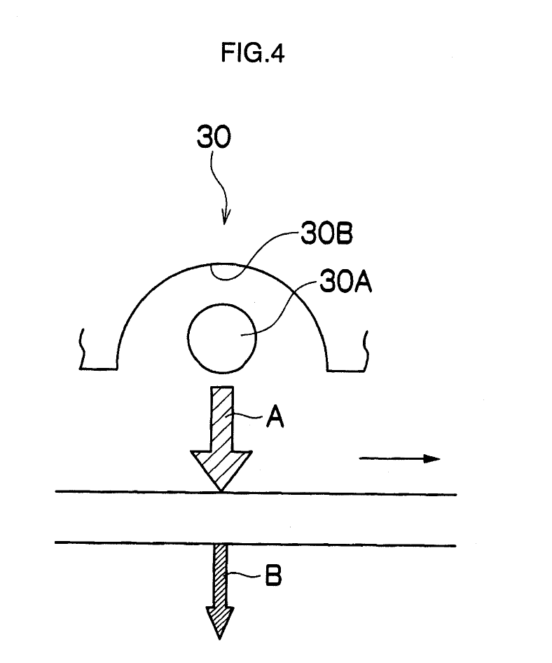

In the embodiment, as shown in FIG. 4, electromagnetic waves radiated during heating is desirably composed of such a wavelength band (a transmittance of 20% or higher and 50% or lower) that a thermal energy B of 20% or more and 50% or less of the total thermal energy A radiated from the near-infrared ray lamp 30A onto the front surface of the polyester film 18 transmits from the front surface to the rear surface. In this case, a radiant heat radiated outside the film front surface is not contained in the total thermal energy A. Whether or not the transmittance of 20% or more and 50% or less is attained can be measured as follows. That is, heat flux values (W/m²) before and after the radiant heat is passed through the film are measured using a radiant flux sensor made by Captec Corp., and the ratio thereof is determined to acquire a transmittance.

The wavelength band of near-infrared rays having this transmittance preferably has a maximum energy wavelength in the range of 0.8 μm or higher and 2.5 μm or lower. However, in the case of a constant wavelength band, the transmittance changes as the thickness of the polyester film 18 changes. Therefore, the maximum energy wavelength is not limited to 0.8 μm or higher and 2.5 μm or lower, and the region of the maximum energy wavelength is preferably shifted corresponding to the thickness of the polyester film 18. Usually in production of a base film for an optical film, the thickness of the polyester film 18 before longitudinal drawing is in the range of 800 μm or more and 4,000 μm or less, and the region of the maximum energy wavelength may be controllably shifted corresponding to the thickness.

A shift control apparatus to shift the wavelength is not especially shown as a diagram, but the shift control apparatus may comprise, for example, a memory to store data showing a relation between the thickness of the polyester film 18 and the transmittance at the maximum energy wavelength (the relation is previously determined off-line), a measurement device to measure the thickness of the polyester film 18 before longitudinal drawing (the measurement can be carried out on-line or off-line), and a variation device to vary the maximum energy wavelength of the near-infrared ray heater 30 to produce the above-mentioned transmittance based on the data in the memory and the measurement result.

Thus heating the polyester film 18 being longitudinally drawn by using the heating apparatus (near-infrared ray heater 30) to radiate the radiant heat to transmit through the polyester film 18 can make small the temperature difference between the film front and rear surfaces. Thereby, curling of the polyester film 18 during longitudinal drawing can effectively be suppressed. In this case, the curl value of the polyester film 18 after transverse drawing described later is preferably equal to or less than 20 mm.

A method for measuring a curl involves cutting out a strip-shaped sample 20 mm wide and 333 mm long from the polyester film 18 after transverse drawing, raising the sample and fixing the center thereof, and measuring the distances between the tangent to the sample at the central part thereof and both end parts separated from the tangent due to curling. The average measurement value for both the end parts is represented as a curl value in mm unit.

In the embodiment, the temperature difference between the front and rear surfaces of the polyester film 18 in the longitudinal drawing step section 20 is preferably equal to or lower than 20° C. As a thermometer to measure the temperature difference of the film front and rear surfaces, for example, a radiation thermometer can suitably be used.

The influence of the temperature difference between the front and rear surfaces of the polyester film 18 emerges as a peak difference in X-ray diffraction between the film front and rear surfaces and a difference in maximum refractive index in the film conveyance direction therebetween. Therefore, specifying the differences in the peak height and the maximum refractive index also can more securely suppress the generation of a curl. Specifically, on completion of the longitudinal drawing step, it is preferable that peak heights in the X-ray diffraction for the film front and rear surfaces on completion of the longitudinal drawing step have a relationship where the peak height for one surface having the higher peak height is 200 or lower when the peak height for one surface having the smaller peak height out of the front and rear surfaces of the film is defined as 100, and that the difference in refractive index in the film conveyance direction between the film front and rear surfaces is 0.04 or less.

Therefore, when the polyester film 18 being longitudinally drawn is heated by the near-infrared ray heater 30 so that the transmittance becomes 20% or higher and 50% or lower, it is preferable that the difference between the calorific values imparted to the front and rear surfaces of the polyester film 18 is monitored by at least one item of three items: the difference in temperature between the front and rear surfaces, the difference in the peak height of the X-ray diffraction therebetween and the difference in the maximum refractive index therebetween.

The polyester film 18 longitudinally drawn in the longitudinal drawing step section 20 as described above is transversely drawn in the transverse drawing step section 24.

The film is heated in the transverse drawing section before drawing. The temperature of the film during transverse drawing is preferably in the range of from the glass transition temperature to a temperature 100° C. higher than the glass transition temperature, and more preferably in the range of from a temperature 10° C. higher than the glass transition temperature to a temperature 60° C. higher than that. As a heating method, a heater using hot air or infrared rays can be used. The transverse draw ratio is selected depending on characteristics required for the film as in the longitudinal drawing, but is preferably 2 to 5 times in the case of the embodiment.

The transversely drawn film is thermally fixed. The thermal fixation temperature is preferably in the range of from a temperature 50° C. lower than the melting point of the film to a temperature 5° C. lower than that, and more preferably in the range of from a temperature 40° C. lower than that to a temperature 15° C. lower than that. The time necessary for the thermal fixation depends on performances required for the film, but is preferably in the range of from 3 sec to 30 sec. The film thermally fixed is thermally relaxed by about 0% or more and 10% or less, and usually by about 0.5% or more and 8% or less in the width direction, cooled, and then carried out from the transverse drawing step. The polyester film according to the present invention has a thickness in the range of from 30 μm or more and 400 μm or less, and preferably 50 μm or more and 300 μm or less after the finish of the transverse drawing.

The oriented polyester film 18 produced through the film foaming step section 15, the longitudinal drawing step section 20 and the transverse drawing step section 24 as described heretofore may be a base film for an optical film. Thereby, a film can be provided which has little thickness unevenness and curling, and excellent flatness.

### EXAMPLES

In Examples satisfying the conditions of the present invention in the film heating in the longitudinal drawing step section and Comparative Examples not satisfying those, using the apparatus for producing an oriented thermoplastic resin film according to the present invention shown in FIG. 1, tests were made how different the degrees of curling of films were.

The tests used a polyester film in Examples and also Comparative Examples. Then, the longitudinal drawing was carried out in the longitudinal drawing step section while the front surface (one surface) of the film was being heated using an infrared ray heater (IR heater) which could vary the wavelength in the range of from 1 to 5 μm. The temperature difference between the film front and rear surfaces during heating was measured at an emissivity of 0.95 using a radiation thermometer.

Successively, the film longitudinally drawn was transversely drawn in the transverse drawing step section and the film transversely drawn was measured for a curl. The curl was measured by the method described before. Since the acceptable limit of the curl values of films in optical applications is 20 mm, a film having a curl value equal to or less than 20 mm was defined as passing.

In Examples and also Comparative Examples, the draw ratio in the longitudinal drawing step section was set at three times; and that in the transverse drawing step section was set at four times.

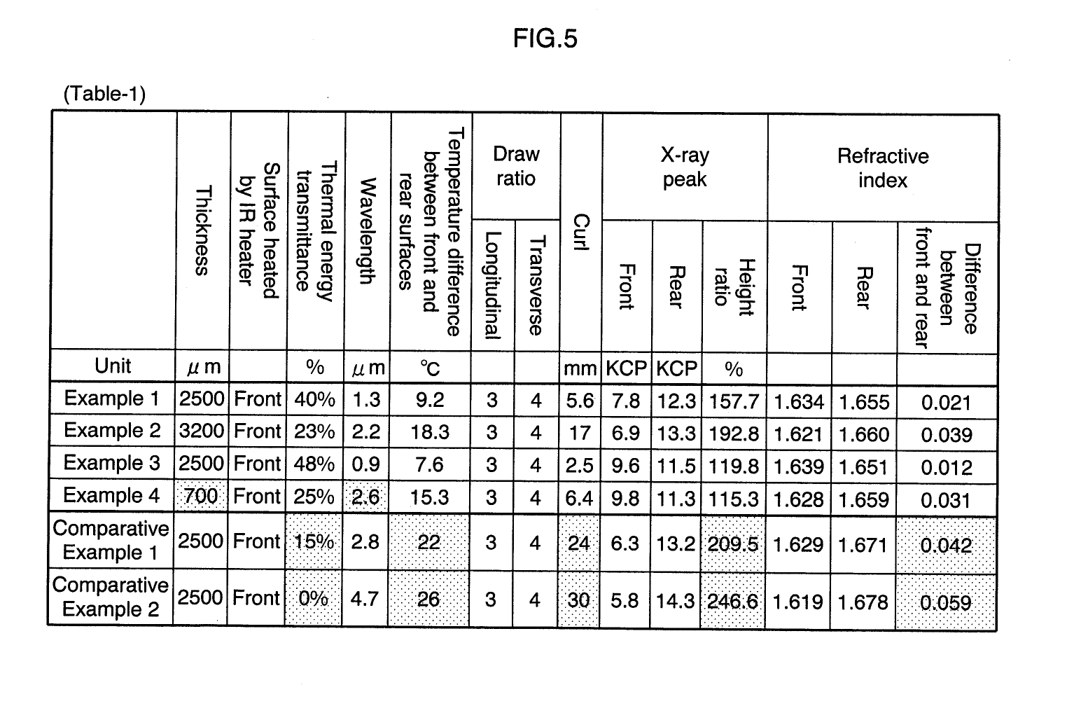

Test conditions and curl values of films in Examples 1 to 4 and Comparative Examples 1 and 2 are as shown in Table 1 in FIG. 5.

In Example 1, a film of 2,500 μm in thickness was radiantly heated by near-infrared rays of 1.3 μm in wavelength so that a thermal energy of 40% of the total thermal energy transmitted from the front surface to the rear surface of the film. Here, the transmittance of the thermal energy satisfying the embodiment was in the range of 20% to 50%.

In Example 2, a film of 3,200 μm in thickness was radiantly heated by near-infrared rays of 2.2 μm in wavelength so that a thermal energy of 23% of the total thermal energy transmitted from the front surface to the rear surface of the film.

In Example 3, a film of 2,500 μm in thickness was radiantly heated by near-infrared rays of 0.9 μm in wavelength so that a thermal energy of 48% of the total thermal energy transmitted from the front surface to the rear surface of the film.

In Example 4, a film of 700 μm in thickness was radiantly heated by electromagnetic waves of 2.6 μm in wavelength, which slightly exceeds the region of near-infrared rays, so that a thermal energy of 25% of the total thermal energy transmitted from the front surface to the rear surface of the film.

In Comparative Example 1, a film of 2,500 μm in thickness was radiantly heated by electromagnetic waves of 2.8 μm in wavelength, which exceeds the region of near-infrared rays, so that a thermal energy of 15% of the total thermal energy transmitted from the front surface to the rear surface of the film.

In Comparative Example 2, a film of 2,500 μm in thickness was radiantly heated by electromagnetic waves of 4.7 μm in wavelength, which largely exceeds the region of near-infrared rays, so that a thermal energy of 0% of the total thermal energy transmitted from the front surface to the rear surface of the film. That is, the thermal energy did not transmit through the film.

As the results, as is clear from Table 1, Examples 1 to 4 could make the temperature differences between the film front and rear surfaces as small as in the range of 7.6 to 18.3° C., which was followed by the curl values of the films in the range of 2.5 to 17 mm, any of which satisfied the passing line being equal to or less than 20 mm. Especially the cases where the thermal energy transmittances of Examples 1 and 3 were 40% and 48%, respectively, gave the temperature differences between the film front and rear surfaces of 9.2° C. and 7.6° C. and curl values of 5.6 mm and 2.5 mm, which were remarkably good results. The reason that Example 4 gave a curl value as small as 6.4 mm in spite of a temperature difference between the film front and rear surfaces of 15.3° C., which was higher than those in Examples 1 and 3, is supposedly because the film hardly curls by nature since the film thickness was 700 mm, which was thinner than those in Examples 1 and 3.

By contrast, since Comparative Examples 1 and 2, respectively, gave thermal energy transmittances of 15% and 0%, which were less than 20%, the curl values were as large as 24 mm and 30 mm, which could not satisfy the passing line being equal to or less than 20 mm.

In the case, not shown in Table 1, where the thermal energy transmittance exceeded 50%, the temperature of the film during longitudinal drawing could not be raised to the longitudinal drawing temperature and the longitudinal drawing could not be carried out so that the drawing ratio became three times.

Examination of “the height ratios” of X-ray peaks and “the differences between the film front and rear surfaces” in refractive indexes in Examples 1 to 4 and Comparative Examples 1 and 2 reveals that “the temperature differences” between the film front and rear surfaces had proportional relations with “the height ratios” and “the differences between the film front and rear surfaces”. That is, if films had nearly the same thickness, small “temperature differences” between the film front and rear surfaces gave small “height ratios” of X-ray peaks and small “differences between the film front and rear surfaces” in refractive indexes. Therefore, it is understood that specifying “the height ratio” of X-ray diffraction peaks and “the difference between the film front and rear surfaces” in refractive index in addition to the temperature difference between the film front and rear surfaces also can more securely suppress the generation of a curl. Specifically, it is preferable that peak heights in the X-ray diffraction for the film front and rear surfaces have a relation that a peak height for one surface having the higher peak height is equal to or lower than 200 where a peak height for one surface having the smaller peak height out of the film front and rear surfaces is set as 100. It is also preferable that “the difference between the film front and rear surfaces” in refractive index is equal to or less than 0.04.

The embodiments have been described heretofore, but the present invention is not limited to the embodiments, and various changes and modifications may be made. For example, in the above, a radiant heater was described by taking as an example a heater using near-infrared rays (near-infrared ray heater), but another heater, for example, a heater using intermediate infrared rays, can be used.

1. A process for producing an oriented thermoplastic resin film,
comprising the longitudinal drawing step of longitudinally drawing a belt-like thermoplastic resin film while one surface of the front and rear surfaces of the thermoplastic resin film is being heated by radiant heating,
wherein electromagnetic waves radiated during the heating are composed of a wavelength band having such a transmittance that a thermal energy of 20% or more and 50% or less of the total thermal energy radiated onto the one surface of the thermoplastic resin film can transmit from the one surface to the other surface.

2. The process for producing an oriented thermoplastic resin film according to claim 1,
further comprising the shift control step of shifting the wavelength band so that the transmittance is attained, depending on the thickness of the thermoplastic resin film.

3. The process for producing an oriented thermoplastic resin film according to 2,
wherein the thermoplastic resin film has a thickness of 800 μm or more and 4,000 μm or less before the longitudinal drawing.

4. The process for producing an oriented thermoplastic resin film according to claim 3,
wherein the thermoplastic resin film is a polyester film.

5. The process for producing an oriented thermoplastic resin film according to claim 1,
further comprising the step of controlling so that the difference in temperature between the one surface and the other surface of the thermoplastic resin film is 20° C. or lower in the heating.

6. The process for producing an oriented thermoplastic resin film according to claim 1,
wherein the electromagnetic waves radiated during the heating are near-infrared rays of a maximum energy wavelength of 0.8 μm or higher and 2.5 μm or lower.

7. The process for producing an oriented thermoplastic resin film according to claim 1,
further comprising the step of controlling so that peak heights in the X-ray diffraction for the front and rear surfaces of the oriented thermoplastic resin film on completion of the longitudinal drawing step have a relationship where the peak height for one surface having the higher peak height is 200 or lower when the peak height for one surface having the smaller peak height out of the front and rear surfaces of the film is defined as 100, and so that the difference in refractive index in the film conveyance direction between the front and rear surfaces of the film on completion of the longitudinal drawing step is 0.04 or less.

8. The process for producing an oriented thermoplastic resin film according to claim 1,
further comprising a transverse drawing step after the longitudinal drawing step.

9. The process for producing an oriented thermoplastic resin film according to claim 8,
wherein the oriented thermoplastic resin film has a curl value after the transverse drawing, of 20 mm or lower.

10. A base film for an optical film,
wherein the base film is produced by a process for producing an oriented thermoplastic resin film according to claim 1.

11. An apparatus for producing an oriented thermoplastic resin film,
comprising a longitudinal drawing step section to longitudinally draw a belt-like thermoplastic resin film while one surface of the front and rear surfaces of the thermoplastic resin film is being heated by a radiant heater,
wherein electromagnetic waves radiated by the heater are in a wavelength band having such a transmittance that a thermal energy of 20% or more and 50% or less of the total thermal energy radiated onto the one surface of the thermoplastic resin film transmits from the one surface to the other surface.

12. The apparatus for producing an oriented thermoplastic resin film according to claim 11,
further comprising a control apparatus which controls the wavelength band so that the transmittance is achieved, depending on the thickness of the thermoplastic resin film,
wherein electromagnetic waves radiated from the heater are near-infrared rays having a maximum energy wavelength of 0.8 μm or higher and 2.5 μm or lower.

13. The process for producing an oriented thermoplastic resin film according to claim 1,
wherein the thermoplastic resin film is a polyester film.

14. The process for producing an oriented thermoplastic resin film according to claim 7,
further comprising a transverse drawing step after the longitudinal drawing step.
